(19) United States
(12) Patent Application Publication
(10) Pub. No.: US 2025/0053002 A1
(43) Pub. Date: Feb. 13, 2025

(54) WIDE-FIELD VIDEO DISPLAY DEVICE

(71) Applicant: KOPIN CORPORATION, WESTBOROUGH, MA (US)

(72) Inventor: YOICHI IBA, HACHIOJI (JP)

(73) Assignee: KOPIN CORPORATION, WESTBOROUGH, MA (US)

(21) Appl. No.: 18/721,370

(22) PCT Filed: Dec. 23, 2021
(86) PCT No.: PCT/JP2021/047805

§ 371 Date: Jun. 18, 2024

(30) Foreign Application Priority Data
Dec. 23, 2021 (WO) PCT/JP2021/047805

(51) Int. Cl. G02B 27/00; G02B 17/08; G06F 1/16

(52) U.S. Cl. CPC G02B 27/0081; G02B 17/0856; G06F 1/163

(57) ABSTRACT

A look-in type wide-field video display device (10) is fitted to the head of a user (U) by applying a pinching force thereto from front and back directions. The wide-field video display device comprises: a device main body (11) provided with a display element and an eyepiece optical system; a forehead pad (13) which is provided projecting from the device main body and which comes into contact the forehead of the user; and a fitting member (12) which applies a pinching force to the head by way of the forehead pad and an occipital contacting body. A vertical FOV of the eyepiece optical system is 23° or more. A total weight of the wide-field video display device forward of the forehead pad is 300 gf or less. All or part of a part the forehead pad that comes into contact with the forehead of the user is located in a range that is a distance 20 mm to 40 mm above an optical axis of the eyepiece optical system, and the forehead pad and the device main body move up and down in conjunction with movement of eye muscles with which the line of sight of the user is moved up and down.

### TECHNICAL FIELD

The present invention relates to a look-in type wide-field video display device.

### BACKGROUND ART

In recent years, HMDs (head mounted displays) (hereinafter referred to as “VR HMDs”) intended for use in VR (virtual reality) applications have begun to attract attention as an example of look-in type wide-field video display devices.

Furthermore, with regard to HMDs, not limited to HMDs for VR applications, mechanisms for fitting the HMD to the face have been invented, with the ideal situation being that a housing can be firmly fixed to the face so as not to move (see Patent literature article 1).

### PRIOR ART LITERATURE

### Patent Literature

[Patent literature article 1] International Publication No. 2015/125508

### SUMMARY OF INVENTION

### Problems to be Resolved by the Invention

When the HMD is fixed to the face, the range of incidence of image light onto the eyeball, defined by an exit pupil, is also fixed. For this reason, when the angle of rotation of the eyeball in a vertical direction becomes large, there is a problem in that the image light is blocked by the pupil, causing vignetting at the pupil.

The present invention has been made in consideration of the above-mentioned points, and the objective thereof is to provide a wide-field video display device capable of suppressing vignetting at the pupil in a state in which the user's line of sight has moved up or down.

### Means for Overcoming the Problem

A wide-field video display device according to an embodiment of the present invention is a look-in type wide-field video display device which is fitted to the head of a user by applying a pinching force thereto from front and rear directions, characterized by including a device main body provided with a display element and an eyepiece optical system accommodated in a housing, a forehead pad which is provided projecting from the device main body and which comes into contact the forehead of the user, an occipital contacting body that comes into contact with the back of the head of the user, and a fitting member which applies a pinching force by way of the forehead pad and the occipital contacting body, wherein: a vertical FOV of the eyepiece optical system is 23° or more; a total weight of the wide-field video display device forward of the forehead pad is 300 gf or less; and all or part of a part of the forehead pad that comes into contact with the forehead of the user is located in a range that is a distance 20 mm to 40 mm above an optical axis of the eyepiece optical system.

### Effect of the Invention

According to the present invention, since the part of the forehead pad that comes into contact with the user's forehead is located in the abovementioned range, the forehead pad and the device main body can be moved up and down in conjunction with movement of eye muscles with which the line of sight of the user is moved up and down. Here, vertical rotation of the eyeball resulting from vertical movement of the line of sight of the user causes the frontalis muscle, which is one muscle of facial expression, to move, and the skin above the eyebrow moves up and down accordingly. As a result of this movement, the forehead pad that is in contact with an area above the eyebrows also moves up and down, and the display element and the eyepiece optical system of the device main body also move up and down together with the forehead pad. Consequently, the display element and the eyepiece optical system also move up and down in conjunction with the vertical movement of the user's line of sight, making it possible to avoid the image light being blocked at the pupil, and thereby making it possible to suppress the occurrence of vignetting at the pupil.

### BRIEF DESCRIPTION OF THE DRAWINGS

FIG. 1 is an explanatory diagram for comparison with FIG. 8, illustrating a state in which a video is being viewed on a wide-field video display device according to the present invention.

FIG. 2 is a configuration diagram of one example of an eyepiece optical system and a display element applied to a wide-field video display device according to an embodiment.

FIG. 3 is a drawing illustrating a normal optical path.

FIG. 4A is a side view illustrating a schematic configuration of the wide-field video display device according to the embodiment, and FIG. 4B and FIG. 4C are side views similar to FIG. 4A, illustrating states in which the line of sight has been moved up and down.

FIG. 5A is a plan view of FIG. 4A, and FIG. 5B and FIG. 5C are plan views similar to FIG. 5A, illustrating modified examples of a fitting member and a forehead pad.

FIG. 6 is an explanatory diagram of an optical system and an exit pupil of a typical HMD.

FIG. 7 is an explanatory diagram of the relationship between the optical system, the exit pupil, and the pupil of a typical HMD.

FIG. 8 is an explanatory diagram illustrating a state in which vignetting occurs at the pupil with a conventional HMD.

### MODES OF EMBODYING THE INVENTION

Conventionally, fitting mechanisms of HMDs have been designed such that the HMD can be fixed as securely as possible to the face, regardless of the application. Meanwhile, in particular in HMDs for VR applications, progress is being made in expanding the FOV (field of view, also referred to as “field of view angle”) to increase the field of view. Here, in the present specification and claims, the term “vertical FOV” refers to an angle obtained by summing upper and lower angles.

When the user directs his or her line of sight to an upper or lower image edge in an HMD with such an expanded FOV, the angle of rotation of the eyeball in a vertical direction increases as the FOV expands, and the pupil is also displaced significantly up and down. However, in a conventional HMD, the HMD is fixed to the face regardless of the rotation of the eyeball, and the position of image light from the HMD relative to the face is also fixed. As a result, in a conventional HMD, image light passing through the exit pupil with little aberration is blocked at the pupil, which is displaced up or down (hereinafter referred to as “vignetting” at the pupil), resulting in problems such as distortion, blurring, and shadows in the observed image.

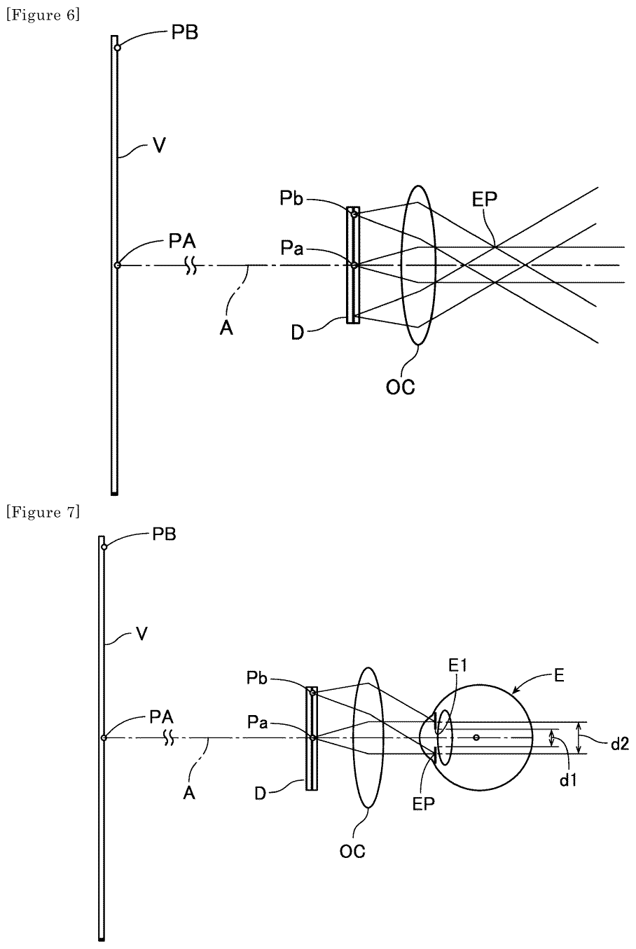

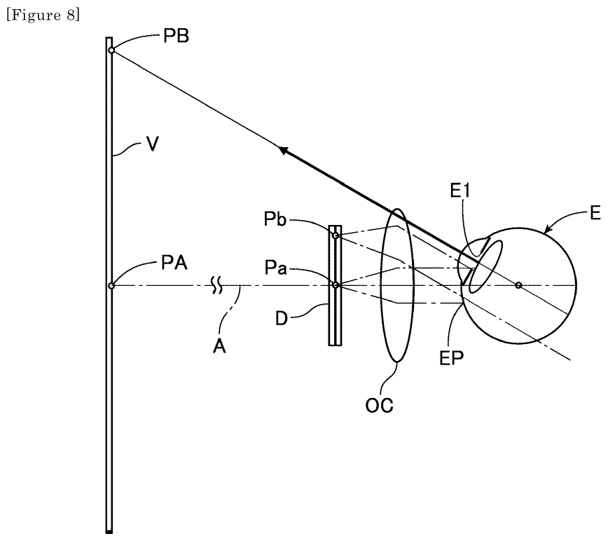

An example of vignetting at the pupil will now be described with reference to FIG. 6 to FIG. 8. FIG. 6 is an explanatory diagram of the optical system and the exit pupil of a typical HMD. FIG. 7 is an explanatory diagram of the relationship between the optical system, the exit pupil, and the pupil of a typical HMD. FIG. 8 is an explanatory diagram illustrating a state in which vignetting occurs at the pupil with a conventional HMD.

As illustrated in FIG. 6, a display element D and an eyepiece optical system OC are arranged in order, side by side, and an exit pupil EP is established on the opposite side of the eyepiece optical system OC to the display element D. Further, a virtual image V visually recognized by the user is established by means of image light that has passed through the eyepiece optical system OC from the display element D and enters the user's eyeball E (see FIG. 7).

As illustrated in FIG. 7, the exit pupil EP is established at the same position as a pupil E1 of the eyeball E of the user. A diameter dimension d1 of the pupil E1 varies, but here is assumed to be 4 mm. Further, a diameter dimension d2 of the exit pupil EP should be a predetermined dimension larger than the diameter dimension d1 of the pupil E1, and is assumed to be 8 mm, which is twice the diameter dimension d1.

A virtual image point PA can be visually recognized by means of image light that has passed through the eyepiece optical system OC, corresponding to a display point Pa of the display element D that overlaps an optical axis A of the eyepiece optical system OC. Further, a virtual image point PB can be visually recognized by means of image light that has passed through the eyepiece optical system OC, corresponding to a display point Pb at an upper limit position of a display region of the display element D. The virtual image point PB is in a position at the upper limit of the virtual image V or in the vicinity of the upper limit.

As illustrated in FIG. 7, when the user looks with the virtual image point PA as the center of the field of vision, the pupil E1 falls within the exit pupil EP. This allows the user to visually recognize the virtual image V that is located above the optical axis A and a predetermined distance below the virtual image point PB, and the virtual image V fits within the user's field of vision.

As illustrated in FIG. 8, when the user looks with the virtual image point PB near the center of the field of vision, the eyeball E is rotated upward. Here, FIG. 8 illustrates an assumed state in which an average value of a distance from the pupil E1 to a center of rotation of the eyeball E is 10 mm, and the eyeball E is rotated upward by approximately 37°. In this state, the pupil E1 is displaced upward by approximately 6 mm compared with the state in FIG. 7. Further, although not illustrated in the drawing, when the eyeball E is rotated upward by approximately 11.5°, the pupil E1 is displaced upward by 2 mm. Meanwhile, since the HMD is fixed to the face, the positions of the display element D, the eyepiece optical system OC and the exit pupil EP relative to the center of rotation of the eyeball E are not displaced, and are fixed.

Since we have assumed that the diameter dimension d1 of the pupil E1 is 4 mm and the diameter dimension d2 of the exit pupil EP is 8 mm, in the state in FIG. 7, a distance between an upper edge of the pupil E1 and an upper edge of the exit pupil EP is 2 mm. Furthermore, a distance between a lower edge of the pupil E1 and the upper edge of the exit pupil EP is 6 mm. Therefore, when the eyeball E rotates upward by approximately 11.5°, the upper edge of the pupil E1 and the upper edge of the exit pupil EP overlap, and if the amount of rotation of the eyeball E increases further, vignetting occurs at the pupil E1. Furthermore, in the state in FIG. 8 in which the eyeball E has been rotated upward by approximately 37°, the positions of the lower edge of the pupil E1 and the upper edge of the exit pupil EP are identical, and image light is almost completely blocked by the vignetting at the pupil E1.

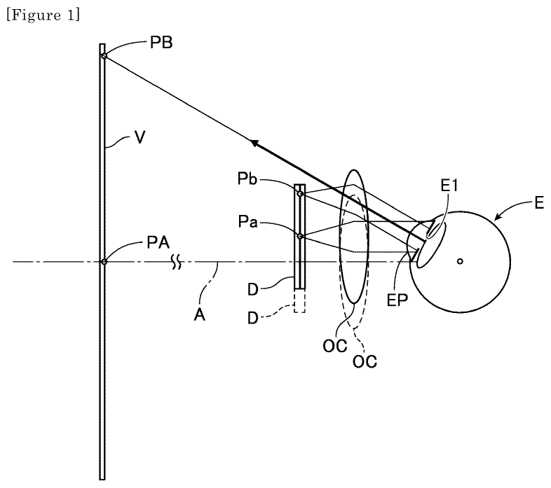

FIG. 1 is an explanatory diagram for comparison with FIG. 8, illustrating a state in which a video is being viewed on a wide-field video display device according to the present invention. As illustrated in FIG. 1, in the present invention, the display element D and the eyepiece optical system OC move vertically (move from the positions indicated by the dashed lines in FIG. 1 to the positions indicated by the solid lines) in response to vertical movement of the line of sight (vertical rotation of the eyeball E). Therefore, the exit pupil EP can also be displaced in the vertical direction in response to the vertical movement of the display element D and the eyepiece optical system OC.

This displacement makes it possible to maintain a state in which the pupil E1 falls within the exit pupil EP, even when the user looks with the virtual image point PB near the center of the field of view. This makes it possible to suppress the occurrence of vignetting at the user's pupil E1, and allows the virtual image V ahead of the line of sight to be observed clearly even if the line of sight of the user moves up or down. As described above, the present invention exhibits advantages in wide-field video display devices for images with which the rotation of the eyeball E may exceed 11.5° and the vertical FOV is 23° or more, and in particular has very significant advantages in wide-field video display devices for images with which the rotation of the eyeball E may exceed 37° and the vertical FOV is 74°.

Further, the total weight of the wide-field video display device according to the present invention, forward of the forehead pad and including the device main body provided with the display element D and the eyepiece optical system OC, is set to 300 gf or less. By setting the total weight in this way, it is possible to avoid the application of a large fixing force to prevent the HMD moving relative to the face. This allows the forehead pad and the device main body to move smoothly up and down in response to a movement that rotates the eyeball E vertically (vertical movement of the line of sight), making it possible to allow the eye muscles and the device main body to move together. If the total weight forward of the forehead pad exceeds 300 gf, the amount the device main body moves in conjunction with the vertical movement of the line of sight decreases, and it is therefore preferable for the total weight forward of the forehead pad to be 300 gf or less.

With recent technology, such a wide field of view and weight reduction can be achieved by using a small display element which, while being compact, is provided with sufficient pixels to accommodate a large FOV, and additionally by using a high-magnification, compact eyepiece optical system that can create a virtual image with a large FOV from the small display element. An eyepiece optical system and a display element according to an embodiment of the present invention will now be described.

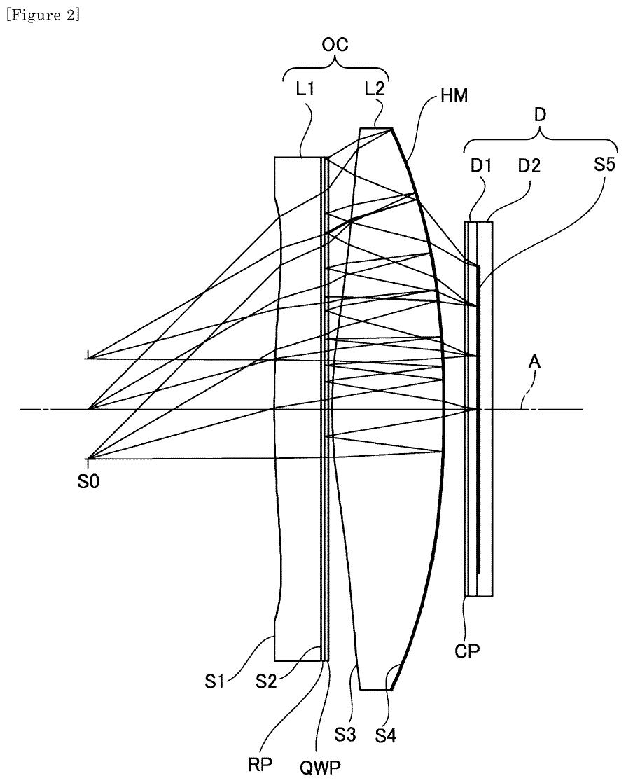

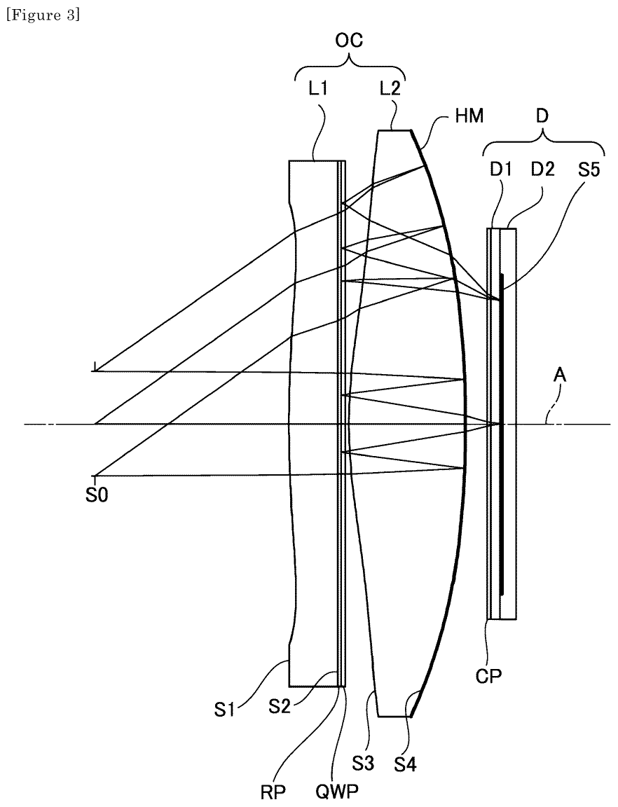

The eyepiece optical system and the display element constituting the wide-field video display device according to the embodiment will be described with reference to FIG. 2 and FIG. 3. FIG. 2 is a configuration diagram of one example of the eyepiece optical system and the display element applied to the wide-field video display device according to the embodiment. FIG. 3 is a drawing illustrating a normal optical path. It should be noted that the invention is not limited to the following embodiment, and can be modified as appropriate within a scope that does not change the gist of the invention. In the following drawings, for the sake of convenience, some components may be omitted.

FIG. 2 and FIG. 3 illustrate the configurations of the eyepiece optical system OC, a circular polarizing plate CP, and the display element D according to the embodiment, the user looking in from the left side of FIG. 2 and FIG. 3 when using the device. The components illustrated in FIG. 2 and FIG. 3 are incorporated into a housing of the wide-field video display device, discussed hereinafter, to form the device main body.

The eyepiece optical system OC, the circular polarizing plate CP, and the display element D are arranged in the stated order from the user's eye side (the left side in FIG. 2 and FIG. 3). The eyepiece optical system OC includes a first lens L1 and a second lens L2 arranged in the stated order from the user's eye side.

A first surface S1, which is a surface of the first lens L1 on the user's eye side thereof, is an aspherical surface. A second surface S2, which is a surface of the first lens L1 on the display element D side thereof, is a flat surface or an approximately flat surface. Further, a reflective polarizing plate (reflective polarizing film) RP and a quarter-wave plate (quarter-wave film) QWP are laminated onto the second surface S2 in the stated order from the user's eye side. The reflective polarizing plate RP is a wire grid polarizing plate or a cholesteric polarizing plate, for example.

A third surface S3, which is a surface of the second lens L2 on the user's eye side thereof, is aspheric and has a convex shape toward the user's eye about the optical axis A of the eyepiece optical system OC. Alternatively, the third surface S3 may be an approximately flat surface about the optical axis A. A fourth surface S4, which is a surface of the second lens L2 on the display element D side thereof, is aspheric and has a convex shape toward the display element D side. In addition, the fourth surface S4 is coated with a half mirror (semi-transmissive mirror) HM.

The circular polarizing plate CP is laminated onto the display element D. Alternatively, the circular polarizing plate CP may be disposed in a space between the eyepiece optical system OC and the display element D (more specifically, between the half mirror HM and the display element D) without being laminated onto the display element D. The circular polarizing plate CP is a linearly polarizing plate with a quarter-wave plate superimposed thereon, for example.

The display element D includes an image display surface S5 on which an image is displayed, a cover glass D1 for protecting the image display surface S5, and a display element substrate D2 for causing the image to be displayed on the image display surface S5. The display element D is a display panel having a large field of view angle, for example an OLED (Organic Light Emitting Diode) panel or a micro LED (Light Emitting Diode) panel. From the viewpoint of reducing the weight and size of the device main body, the display element D has a vertical dimension of 1.5 inches or less.

In a wide-field video display device 10 configured as described above, image light emitted from the display element D follows a normal optical path (including a folded optical path) such as that illustrated in FIG. 3 (and FIG. 2), described next, and enters the user's eye (pupil).

As illustrated in FIG. 3 (and FIG. 2), the image light emitted from the image display surface S5 of the display element D through the cover glass D1 first passes through the circular polarizing plate CP. As a result, the polarization state of the image light becomes a right-handed or left-handed circularly polarized state.

After passing through the circular polarizing plate CP, a part of the image light passes through the half mirror HM, and the remainder is reflected by the half mirror HM and becomes unnecessary light. The image light transmitted through the half mirror HM then passes through the fourth surface S4 and the third surface S3 of the second lens L2 in the stated order.

The image light that has passed through the second lens L2 then passes through the quarter-wave plate QWP. As a result, the polarization state of the image light changes from a right-handed or left-handed circularly polarized state to a linearly polarized state. Here, the azimuth angle of the polarization plane is set to 0°.

The image light that has passed through the quarter-wave plate QWP is then reflected by the reflective polarizing plate RP. Here, the reflective polarizing plate RP reflects light that is in a linearly polarized state with an azimuth angle of 0° and transmits light that is in a linearly polarized state with an azimuth angle of 90°.

The image light reflected by the reflective polarizing plate RP then passes again through the quarter-wave plate QWP. As a result, the polarization state of the image light changes from a linearly polarized state with an azimuth angle of 0° to a left-handed or right-handed circularly polarized state.

The image light that has passed through the quarter-wave plate QWP then passes again through the third surface S3 and the fourth surface S4 of the second lens L2 in the stated order. After passing through the fourth surface S4 of the second lens L2, a part of the image light is reflected by the half mirror HM, and the remainder passes through the half mirror HM and becomes unnecessary light.

The image light reflected by the half mirror HM then passes again through the fourth surface S4 and the third surface S3 of the second lens L2 in the stated order. The image light that has passed through the second lens L2 then passes again through the quarter-wave plate QWP. As a result, the polarization state of the image light changes from a left-handed or right-handed circularly polarized state to a linearly polarized state with an azimuth angle of 90°.

The image light that has passed through the quarter-wave plate QWP is then transmitted through the reflective polarizing plate RP, and passes through the second surface S2 and the first surface S1 of the first lens L1 in the stated order. Then, the image light that has passed through the first lens L1 passes through a pupil plane SO and enters the eye (pupil) of the user. It should be noted that the position of the pupil plane SO is also the expected position of the user's eye (pupil).

The eyepiece optical system OC illustrated in FIG. 2 and FIG. 3 has a folded optical path created using polarization and reflection. In the eyepiece optical system OC, two reflections occur to create the folded optical path. The eyepiece optical system OC is a coaxial eyepiece optical system having the optical axis A at the same position as those of the first lens L1 and the second lens L2. According to the configuration in FIG. 2 and FIG. 3, it is possible to provide a high-magnification, compact eyepiece optical system OC capable of creating a virtual image having a large FOV from the small display element D, which has a vertical dimension of 1.5 inches or less.

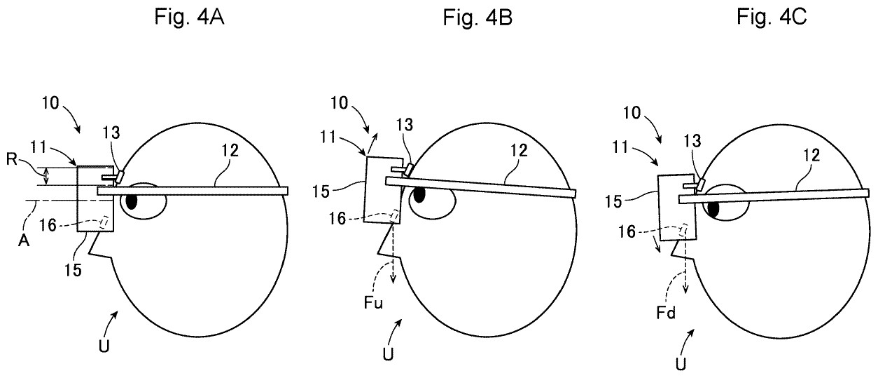

Next, the configuration of the wide-field video display device according to the embodiment will be described. FIG. 4A is a side view presenting a schematic configuration of the wide-field video display device according to the embodiment. It should be noted that, in the following description, unless otherwise specified, “up,” “down,” “left,” “right,” “front,” and “back” are used relative to the user wearing the wide-field video display device 10.

The wide-field video display device 10 illustrated in FIG. 4A is used by being worn on the head of the user U. The wide-field video display device 10 is used as a look-in type device into which the user U looks from the rear, and can be applied to a VR HMD, for example. The wide-field video display device 10 comprises a device main body 11, a fitting member 12, and forehead pads 13.

The device main body 11 is also referred to as a lens barrel. The device main body 11 is provided with a housing 15 for accommodating the eyepiece optical systems OC, the circular polarizing plates CP, and the display elements D (see FIG. 2) which are provided corresponding to the left and right eyes of the user U. The device main body 11 may be configured from a single housing 15, or may have a configuration provided with a left and right pair of housings 15 corresponding to the left and right eyes of the user U.

The device main body 11 includes nose pads 16 provided on the housing 15. The nose pads 16 come into contact with the nose of the user U.

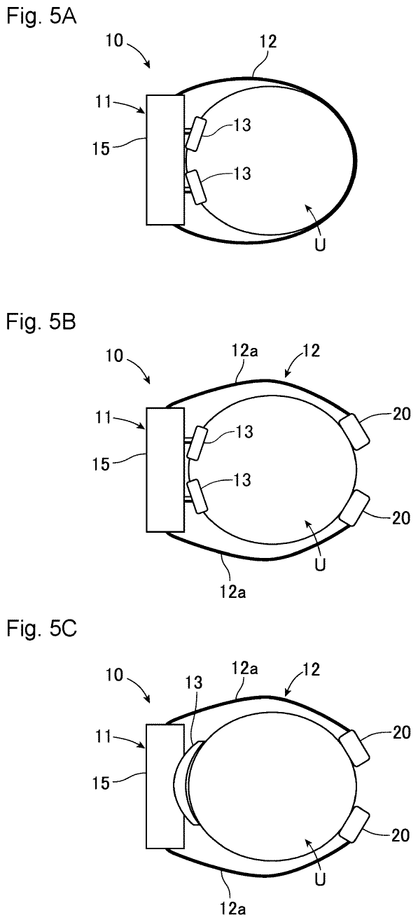

FIG. 5 is a plan view of FIG. 4A. As illustrated in FIG. 5A, the fitting member 12 comprises, for example, a rubber band (elastic member) provided in a loop shape from both the left and right sides of the device main body 11. The fitting member 12 extends from one side of the user U's head to the other side of the head, wrapping round the back of the head while in contact therewith. Here, in the present embodiment, the part of the fitting member 12 that comes into contact with the back of the head is defined as an occipital contacting body, and the fitting member 12 is configured to include the occipital contacting body. The fitting member 12 exhibits elasticity, thereby applying a pinching force to the head of the user U from the front and rear directions by way of the part in contact with the back of the head and the forehead pads 13.

In the present embodiment, the forehead pads 13 are provided as a left and right pair corresponding to the positions of the left and right eyes of the user U. Further, the forehead pads 13 have a shape that is inclined or curved in accordance with the shape of the forehead of the user U when viewed from above.

Returning to FIG. 4A, the forehead pads 13 protrude toward the rear from an upper rear surface of the housing 15, above the optical axis A of the eyepiece optical system (which is omitted from the drawing) accommodated in the housing 15, and are provided so as to come into contact with the front of the head (forehead, above the eyebrows) of the user U. Specifically, although there are differences depending on the individual user U, the forehead pads 13 are provided so as to press the forehead at a position 0 to 20 mm above the eyebrows. In order to be able to press in said range above the eyebrows, all or part of a part of the forehead pads 13 that comes into contact with the forehead of the user U is located in a range R that is a distance 20 mm to 40 mm above the optical axis A of the eyepiece optical system. In other words, the parts of the forehead pads 13 that come into contact with the forehead are provided in positions that fall within the range R, or are provided so as to overlap at least a portion of the range R and to extend beyond at least one of the top and bottom of the range R. The forehead pads 13 press the forehead of the user U backward by means of the elasticity of the fitting member 12.

By setting the range R as the pressing region of the forehead pads 13, the forehead pads 13 come into contact with the skin above the eyebrows on the forehead of the user U. This part of the skin moves up and down in conjunction with the movement of the eye muscles when the user U moves his or her line of sight up and down (rotates the eyeballs up and down). In other words, vertical rotation of the eyeball resulting from vertical movement of the line of sight of the user U causes the frontalis muscle, which is one muscle of facial expression, to move, and the skin above the eyebrow moves up and down accordingly. In conjunction with this skin movement, the forehead pads 13 move up and down as if being dragged, and the device main body 11 also moves up and down accordingly. Consequently, as illustrated in FIG. 4B and FIG. 4C, the forehead pads 13 and the device main body 11 move up and down in conjunction with the movement of the eye muscles with which the line of sight of the user U is moved up and down.

FIG. 4B and FIG. 4C are side views similar to FIG. 4A, illustrating states in which the line of sight has been moved up and down. Compared to the state in FIG. 4A in which the line of sight is parallel to the front-back direction, in FIG. 4B, in a state in which the line of sight has been raised to an upper edge of the image, the device main body 11 can be displaced upward. Further, compared to the state in FIG. 4A, in FIG. 4C, in a state in which the line of sight has been lowered to a lower edge of the image, the device main body 11 can be displaced downward.

Although there are differences depending on the individual user U, if the forehead pads 13 are only in contact above the range R, a skin movement force is insufficient to allow the forehead pads 13 to move readily, and if the forehead pads 13 are only in contact below the range R, the forehead pads 13 are liable to catch on the eyebrows.

The nose pads 16 are positioned on both the left and right sides of the nose of the user U, and are provided primarily to prevent the device main body 11 from shifting left and right relative to the face of the user U. Further, if the total weight of the device main body 11 and the forehead pads 13 is supported by the forehead pads 13 alone, the user U may feel discomfort in his or her head, and the nose pads 16 are provided to alleviate such discomfort.

Here, the total weight of the wide-field video display device 10, forward of the forehead pads 13 and including all or part of the device main body 11 provided with the display elements D and the eyepiece optical systems OC, is set to 300 gf or less. If the total weight exceeds 300 gf, the weight supported by the nose pads 16 becomes too large compared to the weight supported by the forehead pads 13, and the amount the device main body moves 11 in conjunction with the vertical movement of the line of sight decreases. Therefore, the total weight forward of the forehead pads 13 is set to 300 gf or less.

Furthermore, a force applied vertically downward by the nose pads 16 onto the nose of user U is defined as Fu in a state in which the line of sight is raised to the edge of the image, and Fd when the line of sight is lowered to the edge of the image (see FIG. 4B and FIG. 4C). At this time, a pressing position of the forehead pads 13 and a pressing force of the forehead pads 13, which acts as a pinching force for the fitting member 12, are set such that the following formula is satisfied.

$$Fd - Fu > 50 gf$$

This makes it possible to achieve a good balance between setting an appropriate amount of vertical movement of the device main body 11 and reducing the sense of discomfort felt when the device body 11 is worn.

According to the above embodiment, since the forehead pads 13 are pressed against the forehead in the range R, the forehead pads 13 and the device main body 11 can move up and down in conjunction with the movement of the eye muscles that move the line of sight up and down, as illustrated in FIGS. 4A to 4C. Furthermore, this vertical movement also allows the display elements D and the eyepiece optical systems OC (see FIG. 1) constituting the device body 11 to be moved up and down. Therefore, in the present embodiment, the display elements D and the eyepiece optical systems OC can be moved up and down in conjunction with the movement of the eye muscles that move the line of sight up and down.

As a result, in the present embodiment, the exit pupil EP also moves up and down in conjunction with the movement of the eye muscles that move the line of sight up and down, such that the pupil E1 can be kept within the exit pupil EP (see FIG. 1) even if the line of sight is raised such that the upper limit position of the display region of the display element D is in the vicinity of the center of the field of vision, for example. Therefore, in the present embodiment, it is possible to suppress the occurrence of vignetting at the pupil E1, allowing the virtual image V created by the display elements D and the eyepiece optical systems OC to be observed clearly even if the line of sight of the user moves up or down.

The total weight of the wide-field video display device 10, forward of the forehead pads 13 and including all or part of the device main body 11 provided with the display elements D and the eyepiece optical systems OC, is set to 300 gf or less. If the total weight exceeds 300 gf, the amount the device main body 11 moves in conjunction with the vertical movement of the line of sight decreases, and it is therefore preferable for the total weight forward of the forehead pads 13 to be 300 gf or less.

In the present embodiment, in addition to the condition that the total weight forward of the forehead pads 13 is 300 gf or less, the vertical FOV of the eyepiece optical systems OC is set to 23° or more. When the vertical FOV is 23°, in the conventional HMD fixed to the face as described above, vignetting occurs at the pupil E1 when the eyeball E is rotated upward by more than approximately 11.5°, and in a state in which the eyeball E has been rotated upward by approximately 37° (see FIG. 8), the image light is almost completely blocked by the vignetting at the pupil E1. In this regard, in the present embodiment, since the device main body 11 moves up and down in response to the vertical movement of the line of sight (pupil E1), the effect of suppressing and preventing vignetting can be exhibited when the vertical FOV is 23° or more, with which the upward rotation of the eyeball E is greater than approximately 11.5°. In particular, the present embodiment has an extremely large vignetting suppression effect when the vertical FOV is 74°, with which the rotation of the eyeball E may exceed 37°.

Now, the weight of conventional HMDs has increased in order to provide a large FOV, and it has been considered ideal for the HMD to be fixed to the face. In other words, the technology for actively moving the device main body 11, including the eyepiece optical systems, when viewing an image, as in the present embodiment, is a completely different technology that is the exact opposite of the conventional technology, and can be said to be a novel concept that would be extremely difficult to devise.

It should be noted that the present invention is not limited to the abovementioned embodiment, and can be implemented with various modifications. In each of the abovementioned embodiments, sizes, shapes, directions, etc., are not limited to those illustrated in the accompanying drawings, and can be changed as appropriate within a scope in which the advantages of the present invention are exhibited. In addition, the present invention can be modified and implemented as appropriate without departing from the scope of the objective of the invention.

FIG. 5B and FIG. 5C are plan views similar to FIG. 5A, illustrating modified examples of the fitting member and the forehead pad. As illustrated in FIG. 5B and FIG. 5C, for example, the frame member 12 may be configured from a left and right pair of frame members 12a. The frame members 12a pass from both the left and right sides of the device main body 11, past the side of the user U, and reach the vicinity of the back of the head, and are formed in an arc shape that conforms to the shape of the head. Further, each frame member 12a is made from a material that is capable of deforming elastically so as to change the curvature of the arc, examples of such materials including β-titanium and nylon resin.

In FIG. 5B and FIG. 5C, an occipital pad (occipital contacting body) 20 that comes into contact with the back of the head is provided at the rear of each frame member 12a. Consequently, due to the elasticity of the frame members 12a, a pinching force can be applied from the front and rear directions by means of the forehead pads 13 and the occipital pads 20. In other words, due to the elasticity of the frame member 12a, the forehead pads 13 press the forehead of the user U backward, and the occipital pads 20 press the back of the head of the user U head forward.

Further, in the above embodiment, the forehead pads 13 are configured as a left and right pair, but as illustrated in FIG. 5C, the forehead pad 13 may be configured as a single pad that curves along the forehead when viewed from above.

Further, in the above embodiment, a coaxial eyepiece optical system is used, but the present invention Is not limited to this, and it is also possible to use a non-coaxial eyeplece optical system.

### INDUSTRIAL APPLICABILITY

The present invention relates to a look-in type wide-field video display device capable of suppressing the occurrence of vignetting at the pupil.

1. A look-in type wide-field video display device which is fitted to the head of a user by applying a pinching force thereto from front and rear directions, including
a device main body provided with a display element and an eyepiece optical system accommodated in a housing,
a forehead pad which is provided projecting from the device main body and which comes into contact the forehead of the user,
an occipital contacting body that comes into contact with the back of the head of the user, and
a fitting member which applies a pinching force by way of the forehead pad and the occipital contacting body, wherein:
a vertical FOV of the eyepiece optical system is 23° or more;
a total weight of the wide-field video display device forward of the forehead pad is 300 gf or less; and
all or part of a part of the forehead pad that comes into contact with the forehead of the user is located in a range that is a distance 20 mm to 40 mm above an optical axis of the eyepiece optical system.

2. The wide-field video display device as claimed in claim 1, wherein the optical system has a folded optical path created using reflection, and
a vertical dimension of the display element is 1.5 inches or less.

3. The wide-field video display device as claimed in claim 1 or claim 2, wherein the device main body is additionally provided with nose pads that come into contact with the nose of the user, and wherein
the pinching force of the fitting member is set such that, if a force applied vertically downward by the nose pads onto the nose of user is defined as Fd in a state in which the line of sight of the user is lowered to an edge of the image, and Fu when the line of sight is raised to an edge of the image,
$$Fd - Fu > 50 gf .$$
